(19) United States
(12) Patent Application Publication
(10) Pub. No.: US 2008/0015117 A1
(43) Pub. Date: Jan. 17, 2008

(54) REACTOR FOR AUTOMATED PROTEIN ANALYSIS

(75) Inventor: Bakshy Akshaykirti Chibber, Mishawaka, IN (US)

Correspondence Address: ICE MILLER LLP, ONE AMERICAN SQUARE, SUITE 3100, INDIANAPOLIS, IN, 46282-0200, US

(73) Assignee: Ozone Research Frontier Ltd., Indianapolis, IN (US)

(21) Appl. No.: 11/777,160

(22) Filed: Jul. 12, 2007

Related U.S. Application Data
(60) Provisional application No. 60/807,344, filed on Jul. 14, 2006.

(51) Int. Cl. C40B 60/10

(52) U.S. Cl. 506/38

(57) ABSTRACT

The present application relates to a system and apparatus for protein sequencing that incorporates a single reaction vessel with multiple selectable receiver ports system that allows for high throughput and flexibility in the use of a detection system to provide a robust sequencing system.

### PRIORITY

The present nonprovisional application claims priority to U.S. Provisional Patent Application Ser. No. 60/807,344, filed Jul. 14, 2006, and titled AN AUTOMATED REACTOR DEVICE.

### BACKGROUND

The present application relates to the field of protein sequencing. Protein sequencing is used in many biochemical, pharmaceutical, and biomedical research fields to determine the amino acid composition of a sample protein, as well as the sequence in which those amino acids take within a given protein. By determining the amino acid sequence of a new protein, its structural conformation can be better known. Further, an unknown sample protein can be readily identified as a previously known protein through the use of protein sequencing.

Protein sequencing can be performed in a number of different manners, from the use of the Edman degradation reaction, thioacylation, or the use of mass spectrometry, matrix assisted laser desorption ionization, or electrospray ionization (ESI). A brief description of each of these sequencing methods follows.

I. The Edman Degradation Process

The Edman degradation process, first described by P. Edman in 1957, is the basis for modern chemical peptide sequencing. The Edman degradation process operates by removing and identifying each amino acid from the N-terminal end of a protein, thereby allowing a practitioner to identify the composition and sequence of a particular protein. P. Edman, ACTA. CHEM SCAND. 10,761 (1957). More specifically, three reactions are used in the Edman degradation process to remove each N-terminal amino acid: (1) coupling, (2) cleavage, and (3) conversion.

The first reaction, often referred to as coupling, modifies the N-terminal amino acid by adding phenylisothiocyanate (“PITC”) to the amino group, typically in a base-catalyzed reaction. The result of coupling is a phenylthiocarbamyl (“PTC”) protein with the PTC-coupled amino acid occurring at the N-terminal end of the protein. This PTC-coupled amino acid can then be subjected to the second reaction, cleavage, to remove the PTC-coupled amino acid from the protein. The cleavage reaction is typically performed by treating the PTC protein with an anhydrous acid, thereby allowing the sulfur from the PTC group to react with the first carbonyl carbon in the protein chain. As such, this cyclization reaction results in the removal of the first amino acid as an 2-anilino-5(4)-thiozolinone (“ATZ”) derivative, thereby exposing the next N-terminal amino acid on the protein. At this point the, cleaved amino acid, as an ATZ derivative, can be extracted from the residual polypeptide. The cleaved amino acid is then subjected to the third reaction, conversion, wherein the ATZ derivative is converted to a phenylthiohydantoin (“PTH”) amino acid (the “converted amino acid”) by exposing the ATZ derivative to heat and an aqueous, methanolic, or anhydrous acid. The PTH amino acid is more stable and allows for analyzing and identification of the amino acid.

Identification of the PTH amino acid derivative may be performed by either using fluorescent reagents that attach to the cleaved PTH amino acid derivative, or by using fluorescent reagents in the earlier steps of the Edman process to cause a fluorescent-coupled PTH amino acid derivative. However, such reactions are slow, and may result in low percentages of fluorescent coupled amino acid derivatives due to the fact that fluorescent reagents tend to have unfavorable electron configuration. As a result, other methods of identification, including the use of gas liquid chromatography such as high pressure liquid chromatography (“HPLC”), surface phase microextraction chromatography, or mass spectrometry may be used to identify the PTH amino acid derivative.

According to the Edman degradation process, the process of coupling, cleaving, and then converting and identifying the amino acid from the remaining polypeptide is then continued in an iterative fashion until each of the amino acids comprising the original protein have been removed from the N-terminal end and identified.

II. Thioacylation Protein Sequencing

As an improvement on the Edman degradation process, thioacylation allows the use of relatively mild conditions and faster reactions than the original Edman degradation. Typical thioacylation sequencing involves three steps, similar to the Edman degradation, but the coupling step results in attaching the N-terminal amino acid to an insoluble support, allowing for solid phase chemistry to be utilized.

A more complete discussion of thioacylation degradation can be found in U.S. Pat. No. 5,246,865 to Stolowitz et al. (the “Stolowitz Patent”), which is incorporated by reference herein. The Stolowitz Patent indicates that the most of the proposed compounds used for thioacylation have a lower reactivity than the PITC utilized in the Edman degradation process. The Stolowitz Patent discloses the use of more generally available reagents that display better reactivity than the previous thioacylating compounds and allow for better deposition of the cleaved amino acid complexes on a hydrophobic membrane. Thus, the method disclosed in the Stolowitz Patent allows for a more sensitive sequencing system due to the increased reactivity and better retention on a hydrophobic film layer. Further, gas chromatography, mass spectrometry, or chemical ionization mass spectrometry can be used to identify each amino acid complex that is removed from the polypeptide or protein in each iteration of the degradation reaction by the thioacylation protein sequencing process. However, the method disclosed in the Stolowitz Patent utilizes reactants that may modify the side chains of amino acids, making proper sequencing difficult.

III. Mass Spectrometry

Protein sequencing through the use of mass spectrometry is used in many chemical identification applications by measuring the ratio between the mass and charge of a sample. While it is possible to sequence larger polypeptides using mass spectrometry, substantial computing power is required to perform such an analysis. Further, mass spectrometry protein sequencing cannot accurately identify large proteins without modification of the proteins, either through ionization of the proteins (usually performed through electrospray ionization), or chemical or enzymatic digestion of the proteins into smaller polypeptides, each of which may cause the transformation of certain amino acids.

Variations of protein sequencing using mass spectrometry include ladder sequencing. Ladder sequencing utilizes mass spectrometry to compare the resultant peptides that are given off after sequential digesting of proteins. The digestion process may be performed using enzymatic techniques that cleave a protein into multiple polypeptides, or as a modified Edman chemical degradation.

Several methods for performing ladder sequencing may be used, including the use of exopeptidases to cleave off terminal amino acids or dipeptides. This technique has limited application due to the variability of reactivity with respect to the target protein. Alternatively, PITC with a low percentage of phenylisocyanate (“PIC”) has been used to generate several peptide fragments that can be compared to statistically determine the sequence of the protein in a mixture. This PITC/PIC method has the disadvantage of resulting in a substantial loss of peptides during washing cycles, and reducing the effectiveness of ionization of the products, which can significantly alter the effectiveness of sequencing when small protein sample sizes are utilized.

As will be appreciated, the multiple approaches taken to protein sequencing have been made in an attempt to produce a protein sequencing system that: can be used with high sensitivity so that small samples can be accurately sequenced, can be used on a broad range of proteins without selectivity issues; and which allows a higher throughput of samples to allow protein sequencing to be used on a larger and more efficient scale. However, the several approaches noted above do not allow large sample sizes to be run in short time periods due to the multiple iterations of cycling required under the Edman process and its related methods, and due to the focus on obtaining high sensitivity in sequencing results. Conversely a reliable, high throughput system would be greatly appreciated in the art to allow qualitative identification of protein or peptide sequences.

IV. Automated Sequencing

As will be appreciated from the above discussion of protein sequencing, the processes involved in any degradation or enzymatic digestion sequencing is repetitive and can be time consuming—particularly when small sample sizes are involved and care must be taken not to lose a substantial amount of the sample during processing. As such, automated chemical systems have been developed to perform such tasks. For example, U.S. Pat. No. 6,813,568 to Powell et al. (the “Powell Patent”), incorporated by reference herein, claims that chemical analysis results in more easily interpreted sequences than mass spectrometry, but that chemical analysis is “at least ten to twenty times less sensitive than most mass [spectrometry] analyzers.” Col. 1, lns. 50-54. As such, the Powell Patent discloses a microfluidics-based automated protein sequencing system that includes several rotary selector valves and switching valves attached to a processor to direct delivery of reagents and high pressure reactants to use with high pressure or gas chromatography, a cleavage reactor vessel for each protein being analyzed, a conversion reactor for each protein being analyzed, and a restraining means for restraining unprocessed polymer in a reaction vessel.

As such, the automated apparatus disclosed in the Powell Patent includes several valves that must operate under high pressure, and includes a conversion reactor for each protein analyzed. Because conversion can be a rate limiting step in protein sequencing, and the additional conversion vessels required for each sample necessarily adds to the mass of a protein sequencer, a system and apparatus that would allow for reduced cost in manufacturing and increased throughput of samples would be greatly appreciated.

### BRIEF DESCRIPTION OF THE DRAWINGS

FIG. 1 illustrates the top plan view of one embodiment of the bioreactor device.

FIG. 2 illustrates side plan view of the bioreactor device of FIG. 1, sectioned at A-A of FIG. 1.

FIG. 3 illustrates top plan view of the bioreactor device of FIG. 2, sectioned at X-X of FIG. 2.

FIG. 4 illustrates a side perspective view of the bioreactor embodiment shown in FIG. 1.

FIG. 5 illustrates a front plan view of one embodiment of a bioreactor device.

It will be appreciated that elements in the drawings are illustrated for simplicity and have not necessarily been drawn to scale. For example, the dimensions of some of the elements in the drawings may be exaggerated relative to other elements to help to improve understanding of embodiments of the present invention.

### SUMMARY

According to one embodiment of the present application, a protein sequencing system comprises a protein sequence library selected from an organism or group of organisms that encompass one or more unknown protein samples. The system further comprises a bioreactor having at least one reaction vessel (also known as a “reaction chamber”) that is connected to at least one fluid inlet port and a corresponding fluid outlet port. The at least one fluid inlet port and corresponding fluid outlet port can be selectively connected to a plurality of receivers on a rotating member when the receivers are rotated in a horizontal position to be aligned with the at least one fluid inlet port and a corresponding fluid outlet port, and a moving member moves the at least one fluid inlet port and at least one fluid outlet port in a vertical manner to cause the fluid inlet port and fluid outlet port to be in releasable fluid communication with the corresponding receivers. The protein sequencing system further includes at least one cleavage reactant that can cleave one or more amino acids from the unknown protein sample, resulting in a remaining polypeptide or dipeptide, and at least one reactant outlet in fluid connection with at least one of the receivers.

Optionally, each of the plurality of unknown protein samples is bonded to a solid surface within the reaction chamber. Further optionally, the reactant outlet leads to a second reaction chamber. Another alternative embodiment includes a mass spectrometer operable to analyze the cleaved amino acids or any remaining polypeptide or dipeptide. Additionally, cleaved amino acids may optionally comprise the first five or fewer N-terminal amino acids of each of the plurality of unknown protein samples. In one alternative embodiment, the mass spectrometer is further operable to assess the molecular weight of the unknown protein samples. Finally, the protein sequencing system comprises a processor that houses the protein sequence library, where the processor is further operable to compare the first five or fewer N-terminal amino acids of the unknown protein samples to the first five or fewer N-terminal amino acids of the proteins contained within the protein sequence library. Additionally, the processor is operable to compare the molecular weight of the unknown protein samples with the molecular weight of the proteins within the protein sequence library.

In another embodiment, a protein sequencing system comprises a protein sequence library containing protein sequences from one organism or a group of organisms from which one or more unknown protein samples are taken. The protein sequencing system further comprises a bioreactor having a first reaction vessel in fluid communication with at least one fluid inlet port and wherein the first reaction vessel and wherein the first reaction vessel is operable to retain one of the plurality of unknown protein samples. The protein sequencing system further comprises at least one cleavage reactant operable to cleave one or more amino acids from the unknown protein samples to result in a remaining polypeptide or dipeptide, and at least one exit port in fluid connection with the reaction vessel and operable to be selectively moved into fluid connection with at least one of a plurality of receivers contained within a moveable member, and wherein each of the plurality of unknown protein samples is bonded to a solid surface located within the reaction vessel.

Optionally, the protein sequence library is selected after identifying a first five or fewer amino acids comprising at least one of the unknown protein samples. Further optionally, the protein sequence library is derived from a genome of the organism or group of organisms from which the protein samples are taken. For example, the organism may be Homo sapiens. Further optionally, the protein sequencing system of claim comprises a mass spectrometer that is connected to at least one of the plurality of receivers such that the mass spectrometer operable to analyze the molecular weight of any resultant polypeptide or dipeptide from the unknown protein samples, or any cleaved amino acids from the unknown protein samples. Finally, the protein sequencing system comprises a processor that houses the protein sequence library, where the processor is further operable to compare the first five or fewer N-terminal amino acids of the unknown protein samples to the first five or fewer N-terminal amino acids of the proteins contained within the protein sequence library. Additionally, the processor is operable to compare the molecular weight of the unknown protein samples with the molecular weight of the proteins within the protein sequence library.

According to another embodiment of the present application, a protein sequencing system comprises a protein sequence library containing protein sequences from one organism or a group of organisms from which one or more unknown protein samples are taken, and at least one reaction vessel in releasably fluid communication with at least one fluid inlet port and at least one fluid outlet port selected from a plurality of fluid inlet ports and corresponding fluid outlet ports located on a movable platform, and wherein the at least one reactor vessel is operable to retain one of the plurality of unknown protein samples. The protein sequencing system further comprises at least one cleavage reacting operable to cleave one or more amino acids from the unknown protein samples, resulting in a remaining polypeptide or dipeptide, and a mass spectrometer in fluid communication with at least one of the fluid outlet ports, with the mass spectrometer operable to analyze the resultant polypeptide, dipeptide, or cleaved amino acids. Finally, the protein sequencing system comprises a processor housing the protein sequence library, with the processor operable to compare the first five or fewer N-terminal amino acids of the unknown protein samples to the first five or fewer N-terminal amino acids of proteins within the protein sequence library, and wherein the processor is further operable to compare the molecular weight of the proteins within the protein sequence library.

Optionally, the processor is further operable to identify the unknown protein samples by comparing the molecular weight of the remaining polypeptide or dipeptide and comparing the molecular weight to selected portions of the proteins within the protein sequence library. Further optionally, the protein sequencing system processor is also operable to identify the unknown protein samples by comparing the molecular weight of the remaining polypeptide or dipeptide to the molecular weight of portions of the proteins within the protein sequence library. Further optionally, the processor identifies the unknown protein samples by comparing both the molecular weight of the remaining polypeptide or dipeptide and the molecular weight of any cleaved amino acid fragments to identify the unknown protein samples. As another option, the protein sequencing system may comprise a second reaction chamber in fluid connection with at least one of the fluid outlet ports. Optionally, the protein sequencing system has the mass spectrometer in fluid connection with the second reaction chamber. Finally, the protein sequencing system optionally derives the protein sequence library from the genome of the organism or group of organisms from which the plurality of unknown protein samples are taken.

### DETAILED DESCRIPTION

A. Overview

The present application relates to a system and apparatus for performing high throughput protein sequencing with reliable identification of proteins or polypeptides. Contrary to prior sequencing methods that require iterative sequencing of each of the N-terminal amino acids and subsequently identify each amino acid cleaved from the protein or polypeptide to reconstruct a sequence, the present application relates to a system of identifying proteins or polypeptides from an organism or other protein source utilizing a minimal number of cleavage cycles and with no requirement for conversion of the cleaved samples to identify the sample protein or polypeptide.

One embodiment of the present application relates to utilizing a known DNA, RNA, or protein library to act as a known set of sequences against which unknown proteins may be compared for identification. In particular, the identification of proteins or polypeptides from a particular organism or group of organisms (such as populations, subspecies, species, genera, etc.) is used to narrow the universe of potential proteins that are being tested to a discrete protein population. By way of nonlimiting example, a DNA sample, RNA sample, or array of proteins from the organism or groups of organisms may be used to form or extrapolate a library of protein sequences of the relevant protein population for later identification of an unknown protein sample or samples. It will be appreciated that protein population libraries can be identified by using previous methods of DNA or RNA sequencing, mass spectroscopy, or in depth protein sequencing. Because the libraries of genomes for various organisms are now available from many different sources, a protein population for an organism or group of organisms may be readily available, and relevant proteins may be identified without any sequencing performed prior to testing unknown samples.

In one embodiment, a system for identifying proteins comprises the cleavage of about five or fewer N-terminal or C-terminal amino acids from an unknown protein or amino acid using chemistries used in the ladder process, Edman process, thioacylation process, or other known processes. For example, five or fewer coupling and cleavage reactions may be cyclically performed to remove the first five or fewer amino acids from the unknown protein. After each cycle, the cleaved amino acid may be washed off from the reaction vessel and identified. The identification of the first five or fewer amino acids is then recorded as a partial sequence, and that partial sequence is compared to the protein sequence library previously discussed.

It will be appreciated that several proteins from the protein population represented in the protein sequence library may have identical amino acid sequences to that of the unknown sample. This is one reason why the Edman process and other processes previously used require sequencing by identifying each amino acid in an unknown sample to identify the polypeptide or protein. However, according to one aspect of the present application, the molecular weight of each unknown sample is also taken and compared against the molecular weight of the population proteins identified by comparing the first five or fewer amino acids of the unknown sample with the protein sequence library. In this manner, when both the first five or fewer amino acids of an unknown sample and its molecular weight are compared to the first five amino acids and molecular weight of the protein population accumulated for the protein sequence library, nearly all unknown samples from a particular organism can be identified simply by comparing the discovered sequence and molecular weight. As such, identification through limited sequencing can be accomplished without exhaustive and iterative sequencing. In the event that the first five or fewer amino acids and molecular weight cannot positively identify the unknown sample as a single protein or peptide from the identified protein population, additional sequencing may be performed on the unknown sample. In the event that several proteins with identical sequences of the first five amino acids are identified in a protein sequencing library, the first 10 or fewer, or the first 20 or fewer amino acids for each sample could be taken. However, a significant reduction in time taken to identify the samples would be appreciated even if only half of the unknown samples were immediately identifiable through the comparison method, or if.

It will be appreciated that alternative embodiments in which the first 6 or fewer amino acids from the N-terminal or C-terminal end are identified along with the molecular weight of the unidentified protein may be compared to the protein population to identify the unknown protein. Alternatively, embodiments in which the first 10 or fewer amino acids from the N-terminal or C-terminal end are identified along with the molecular weight of the unidentified protein are compared to the protein population to identify the unknown protein. Alternatively, embodiments in which the first 20 or fewer amino acids from the N-terminal or C-terminal end are identified along with the molecular weight of the unidentified protein are compared to the protein population to identify the unknown protein. Alternatively, embodiments in which the first 30 or fewer amino acids from the N-terminal or C-terminal end are identified along with the molecular weight of the unidentified protein are compared to the protein population to identify the unknown protein.

In an alternative embodiment, a protein population or protein sequence library may not be created prior to the sequencing of unknown samples. For example, one or more samples may be processed in a manner that identifies the first 5 or fewer amino acids in sequence, the first 6 or fewer amino acids in sequence, the first 10 or fewer amino acids in sequence, or the first 20 or fewer amino acids in sequence, along with the molecular weight of the one or more unknown protein samples. Once the initial amino acid sequence is identified, a mapped genome may be analyzed to identify all potential proteins that may be produced by the organism in question, or an RNA, DNA, or known protein samples may be probed to identify a protein population that has an identical initial sequence by, for example, a blast search.

According to yet another embodiment of the present application, a short series of ladder sequencing may be utilized to cleave an unknown sample that has been bonded or attached to a solid surface (such as a membrane) into several different sized polypeptide fragments. Once the free fragments are washed, the solid surface may be subjected to mass spectrometry to identify the sequence of a certain number of amino acids within the protein. The location of these identified amino acids, along with the molecular weight of the sample, can then be compared against a previously generated protein sequence library as discussed above, or may be used to probe a genome, RNA, or DNA as previously discussed to identify an unknown protein sample.

It will be appreciated that each of the above embodiments can be performed by obtaining a relatively pure protein sample from a mixed protein sample by utilizing a 2D separation, such as gel electrophoresis or chromatography, to separate out the various proteins in an unknown sample into its individual protein samples. Alternatively, a 1D separation may be performed, with the mass differences of the proteins in a mixed sample may be utilized to identify the multiple proteins in a mixed sample, although such a mixture will complicate analysis of the sample.

### EXAMPLE

An exemplary embodiment of one aspect of the present application would involve the use of an unknown mixed protein sample. The unknown mixed protein sample is subjected to a 2D separation, and a purified protein sample is obtained by pulling out one of the samples from the 2D separation which should hold several molecules of a particular unknown protein. The sample is then adhered to a membrane attached to a reaction vessel and run through an automated system as described below. Reagents are selected to perform a ladder process sequencing by utilizing the PITC/PIC reagents discussed above in a manner to obtain the sequence of the first 6 N-terminal amino acids. After washing the reagents and optionally saving the eluted cleaved peptides and amino acids from the reaction vessel, the remaining fragments still attached to the film are subjected to mass spectrometry to determine the sequence of the first 6 N-terminal amino acids and the molecular weight of the fragments, from which the molecular weight of the entire sample can be derived, if necessary.

In this example, the amino acid sequence for the first 6 amino acids is GDPGGV. A search of a known protein database for the 6 amino acid sequence, in this instance, the database maintained for proteins at the National Center for Biotechnology Information, is searched for the GDPGGV sequence. A total of 46 possible proteins are identified when a search of this 6 amino acid sequence is performed. Additionally, the 46 possible proteins identified include proteins from several different organisms. This list can be substantially reduced by removing all but the known organism from which the sample was taken, if known. Additionally, the number in the protein sequence where the GDPGGV sequence is found is identified in the database, so it can be determined whether the unknown protein was later phosphorylated or otherwise changed from its original state in the organism from which it came.

In the event that no such results are present for a given sequence, a DNA or RNA probe corresponding to the amino acid sequence can be created to identify the sequence in the organism's DNA that codes for the protein, thereby allowing the identification of the protein.

B. Automated System Embodiments

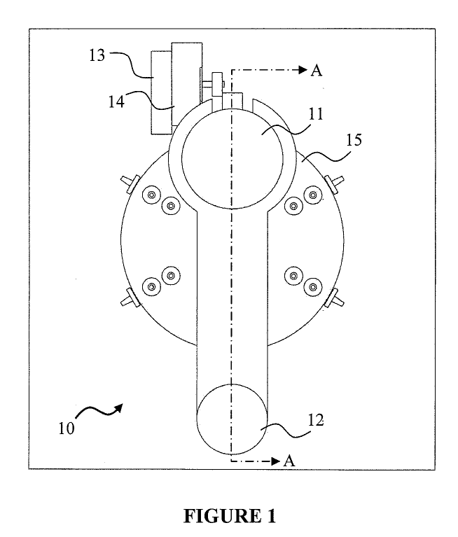

Turning now to FIG. 1, a top view of a bioreactor device (10) according to one embodiment of the present application, bioreactor device (10) of the present invention comprises a first member (11) movably mounted on to a body member (12). Opposite to the body member (12) a post (13) is provided. First member (11) is further supported by a post (13) located opposite to the body member (12). The post (13) is further provided with a first motion imparting mechanism (14) which imparts motion to first member (11). Beneath the first member (11) a second member (15) is located.

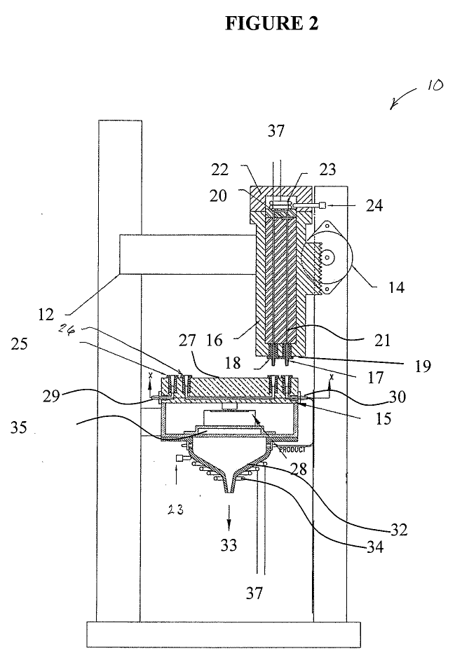

With reference to FIG. 2, a sectional view taken at Section A-A of FIG. 1, it can be noticed that first member (11) comprises a housing (16) provided with an inlet port (17) and an outlet port (18) disposed on a bottom surface (19) of housing (16). A reaction chamber (20) is optionally located within the housing (16) of the first member (11). Channel (21) acts as a fluid communication path between inlet port (17) and outlet port (18) inside housing (16) such that channel (21) passes through reaction chamber (20). Reaction chamber (20) is optionally formed as a two-part construction to allow removal or addition of a substrate inside chamber (20) by providing housing (16) with a removable cap element (22). Removable cap element (22) is optionally provided with sufficient space to accommodate a heating element (23), and a thermostat (24) for controlling the temperature attained by the heating element (23), which may be helpful in driving certain reactions.

Further referring to FIG. 2, a second member (15) is provided with at least one fluid inlet port (25) and at least one corresponding fluid outlet port (26) (collectively referred to as “receivers”, as they are operable to receive inlet port (17) and outlet port (18)) disposed on a top surface (27) of second member (15). Second member (15) is further provided with a second motion imparting mechanism (28) to allow rotation of second member (15) to align inlet port (17) and outlet port (18) to align with one of a plurality of the fluid inlet port (25) and fluid outlet port (26), respectively.

The first motion imparting mechanism (14) and the second motion imparting mechanism (28) together are configured to bring the inlet port (17) and the outlet port (18) of the first member (11) in fluid flow communication with one of the inlet ports (25) and outlet ports (26) respectively of the second member (15), thereby enabling fluid to be supplied to the reaction chamber (20). Once second motion imparting mechanism (28) aligns inlet port (17) and outlet port (18) with one of a plurality of the fluid inlet port (25) and fluid outlet port (26), respectively, as shown in FIG. 2, first motion imparting mechanism 14 moves first member (11) in a vertical direction such that inlet port (17) and outlet port (18) fits within fluid inlet port (25) and fluid outlet port (26), respectively, with a fluid tight seal to allow reactants or reagents to flow from fluid inlet port (25) through inlet port (17), up through channel (21), into reaction chamber (20), back down through channel (21), and out through outlet port (18) and fluid outlet port (26).

According to one embodiment, first motion imparting mechanism (14) is configured to impart a motion to first member (12) in a vertical plane. Alternatively, the second motion imparting mechanism (28) imparts a rotational motion to second member (15) in a horizontal plane as indicated in FIG. 2. However, bioreactor device (1) can be constructed with multiple different motions in which a selected fluid inlet port (25) and fluid outlet port (26) is aligned with inlet port (17) and outlet port (18) and brought into fluid connection therewith.

As can be noticed from FIG. 2, for each inlet port (25) provided in second member (15), a corresponding outlet port (26) is provided. Optionally, each of the multiple inlet ports (25) and each of the multiple outlet ports (26) are paired together and located adjacent to each other to allow proper alignment with inlet port (17) and outlet port (18).

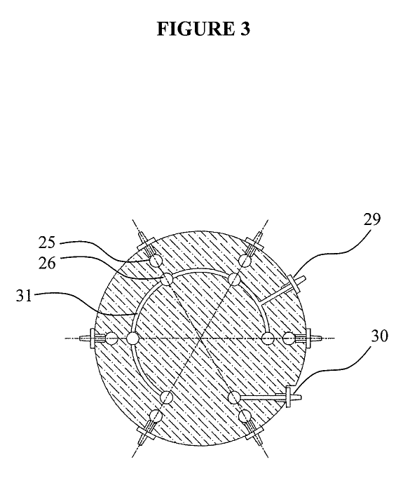

It will be appreciated from a review of FIGS. 2 and 3, that at least one of the multiple fluid inlet ports (25) provided in second member (15) is connectable to a reagent containing unit (not shown) via an inlet such as inlet/outlet (30) such that reagents may be pushed through inlet/outlet (30) through inlet port (25). Similarly, at least one of the multiple fluid outlet ports (26) provided in the second member is connectable to a waste outlet (not shown) through inlet/outlet (29) and at least one of the multiple fluid outlet ports (26) provided in second member (15) is connectable to a product outlet through inlet/outlet (30). Optionally, as shown in FIG. 3, the multiple outlet ports can be connected by means of a canal (31) together to flow to a waste outlet via inlet/outlet (29).

It will be appreciated that selecting a particular fluid inlet port (25) and its corresponding fluid outlet port (26) to align and be placed in fluid connection with inlet port (17) and outlet port (18) will allow a user to select which reagents may be flowed into reaction chamber (20) and/or where any reactants flow. For example, selecting a fluid inlet port (25) and its corresponding fluid outlet port (26) connected to an inlet/outlet (29) that leads to a mass spectrometer, waste container, collection container, or other container allows a single reaction chamber (20) to be used for multiple different reactions, and allows bioreactor (10) to be used for multiple different reactions in an automated fashion.

In another embodiment, a bioreactor device (10) may optionally be provided with an intermediate product collector chamber (32) as shown in FIG. 2 for storing a product withdrawn from reaction chamber (20) through inlet/outlet (30). Product collector chamber (32) is optionally provided with an outlet (33) for releasing any product stored therein. Optionally, a heating means (34) is provided for heating the products stored in product collector chamber (32).

It will be appreciated that the plurality of inlet ports (25) shown in the embodiment of FIG. 3 are not required to be used simultaneously.

In another embodiment, first motion imparting mechanism (14) and second motion imparting mechanism (28) are optionally electrical motors chosen from a wide variety of motors. By way of example, the motors used can be a stepper motor or a geared motor. Further, an appropriate coupling mechanism could be used for coupling the electrical motors to the first and the second members for transfer of motion.

In another embodiment, a controlling unit (35) can be provided in the reactor device. Optionally, controlling unit (35) controls heating element (23), and/or first motion imparting mechanism (14) and second motion imparting mechanism (28). Alternatively, a communication device (36) can be provided for communicating with a remotely located controlling unit thereby enabling controlling the operation of the various components. By way of example, communication device (36) for communicating with controlling unit (35) is a wireless communication device such as a Wi-Fi system.

According to one embodiment, controlling unit (35) can be programmed by the user to determine the sequence in which the inlet port (17) and outlet port (18) of first member (12) are brought in fluid flow communication with fluid inlet port (25) and fluid outlet port (26) of second member (15), as well as the time period in which these portions remain in fluid communication. Further, the temperature of reaction chamber (20) and/or the product chamber (32) is controlled by providing power to heating element (23) for a preset period of time.

In order to supply power to the electrical motor and/or the heating device and various other components of bioreactor device (10), one or more batteries can be located inside the housing or the body or the post or any other suitable location (not explicitly shown in the figures). Alternatively, supply terminals (37) can be brought out of any of the components of the reactor device (10) for supplying power to various components of the reactor device.

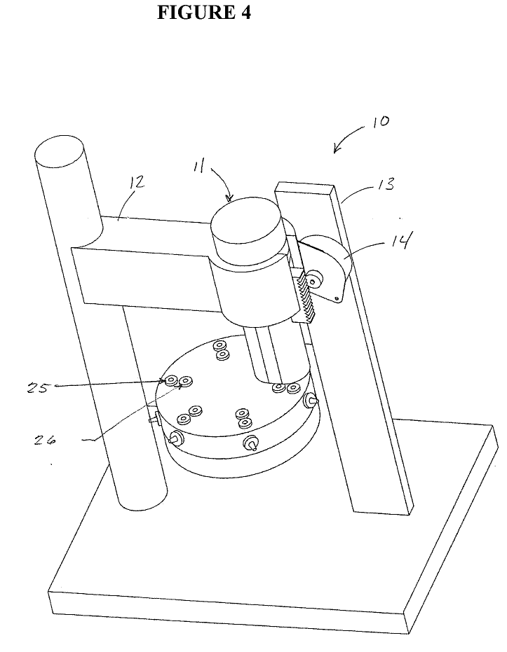

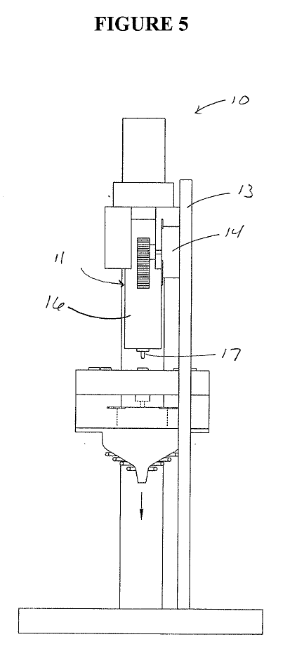

FIGS. 4 and 5 illustrate the side view of bioreactor device (10) and the three dimensional view of the bioreactor device (10) in accordance with the present application.

In application, the bioreactor device (1) may be used by placing a protein sample in reaction chamber (20), and selecting the appropriate fluid inlet port (25) and its corresponding fluid outlet port (26) to align and be placed in fluid connection with inlet port (17) and outlet port (18) to allow a user to flow the desired reagents into reaction chamber (20). Then, after a preselected time, another fluid inlet port (25) and its corresponding fluid outlet port (26) is selected to align and be placed in fluid connection with inlet port (17) and outlet port (18), allowing the reagents and any dipeptides or polypeptide digestion to be flowed out of the reaction chamber and past a mass spectrometer for comparison against the library of proteins as described above. Further, multiple reagents may alternatively be used, and resultant dipeptides or polypeptides may be flowed to a second reaction vessel for further reaction.

Although the embodiments above have been described in detail with reference to preferred embodiments, variations and modifications exist within the scope and spirit of the invention as described and defined in the following claims.

1. A protein sequencing system comprising:
a. a protein sequence library from an organism or group of organisms from which one or more unknown protein samples are taken;
b. a protein sequencer comprising:
i. at least one reaction vessel in fluid communication with at least one fluid inlet port and at least one corresponding fluid outlet port in constant connection with the reaction vessel;
ii. a rotational member comprising a plurality of receivers for receiving the at least one fluid inlet port and at least one corresponding fluid outlet port when the at least one fluid inlet port and at least one corresponding fluid outlet port are aligned with the corresponding receivers;
iii. a first moving member operable to move the at least one fluid inlet port and at least one corresponding fluid outlet port in a vertical direction when the at least one fluid inlet port and at least one corresponding fluid outlet port are horizontally aligned with the corresponding receivers;
iv. a second moving member operable to move the rotational member in a horizontal direction to horizontally align the at least one fluid inlet port and at least one corresponding fluid outlet port with the corresponding receivers;
c. at least one cleavage reactant operable to cleave one or more amino acids from the unknown protein samples and result in a remaining polypeptide or dipeptide;
d. at least one reactant outlet in fluid connection with at least one of the receivers.

2. The protein sequencing system of claim 1, wherein each of the plurality of unknown protein samples is bonded to a solid surface located within the reaction vessel.

3. The protein sequencing system of claim 1, wherein the reactant outlet leads to a second reaction vessel.

4. The protein sequencing system of claim 1, further comprising a mass spectrometer operable to analyze the cleaved amino acids or the any remaining polypeptide or dipeptide.

5. The protein sequencing system of claim 4, wherein the cleaved amino acids comprise the first five or fewer N-terminal amino acids of each of the plurality of unknown protein samples.

6. The protein sequencing system of claim 5, wherein the mass spectrometer is further operable to determine the molecular weight of the unknown protein samples.

7. The protein sequencing system of claim 6, further comprising a processor, the processor housing the protein sequence library, the processor further operable to compare the first five or fewer N-terminal amino acids of the unknown protein samples to the first five or fewer N-terminal amino acids of proteins within the protein sequence library, and wherein the processor is further operable to compare the molecular weight of the unknown protein samples with the molecular weight of the proteins within the protein sequence library.

8. A protein sequencing system comprising:
a. a protein sequence library from an organism or group of organisms from which one or more unknown protein samples are taken;
b. a bioreactor having a first reaction vessel in fluid communication with at least one fluid inlet port and wherein the first reaction vessel is operable to retain one of the plurality of unknown protein samples;
c. at least one cleavage reactant operable to cleave one or more amino acids from the unknown protein samples and result in a remaining polypeptide or dipeptide;
d. at least one exit port in fluid connection with the reaction vessel and operable to be selectively moved into fluid connection with at least one of a plurality of receivers contained within a movable member; and
e. wherein each of the plurality of unknown protein samples is bonded to a solid surface located within the reaction vessel.

9. The protein sequencing system of claim 8, wherein the protein sequence library is selected after identifying a first five or fewer amino acids comprising at least one of the unknown protein samples.

10. The protein sequencing system of claim 9, wherein the protein sequence library is derived from a genome of the organism or group of organisms.

11. The protein sequencing system of claim 10, wherein the organism is Homo sapiens.

12. The protein sequencing system of claim 8, further comprising a mass spectrometer in fluid communication with at least one of the plurality of receivers contained within the movable member, and wherein the mass spectrometer is operable to analyze the molecular weight of resultant polypeptide or dipeptide from the unknown protein samples.

13. The protein sequencing system of claim 12, further comprising a processor, the processor housing the protein sequence library, the processor further operable to compare the first five or fewer N-terminal amino acids of the unknown protein samples to the first five or fewer N-terminal amino acids of proteins within the protein sequence library, and wherein the processor is further operable to compare the molecular weight of the unknown protein samples with the molecular weight of the proteins within the protein sequence library.

14. A protein sequencing system comprising:
a. a protein sequence library from an organism or group of organisms from which one or more unknown protein samples are taken;
b. a bioreactor having at least one reaction vessel in releasably fluid communication with at least one fluid inlet port and at least one corresponding fluid outlet port selected from a plurality of fluid inlet ports and corresponding fluid outlet ports located on a movable platform, and wherein the at least one reaction vessel is operable to retain one of the plurality of unknown protein samples;
c. at least one cleavage reactant operable to cleave one or more amino acids from the unknown protein samples and result in a remaining polypeptide or dipeptide;
d. a mass spectrometer in fluid communication with at least one of the fluid outlet ports, the mass spectrometer operable to analyze the resultant polypeptide, dipeptide, or cleaved amino acid; and
e. a processor, the processor housing the protein sequence library, the processor further operable to compare the first five or fewer N-terminal amino acids of the one or more unknown protein samples to the first five or fewer N-terminal amino acids of proteins within the protein sequence library, and wherein the processor is further operable to compare the molecular weight of the one or more unknown protein samples with the molecular weight of the proteins within the protein sequence library.

15. The protein sequencing system of claim 14, wherein the processor is further operable to identify the unknown protein samples by comparing the molecular weight of the remaining polypeptide or dipeptide to the molecular weight of portions of the proteins within the protein sequence library.

16. The protein sequencing system of claim 15, wherein the processor is further operable to identify the unknown protein samples by comparing both the molecular weight of the remaining polypeptide or dipeptide unknown protein samples and the molecular weight of any cleaved amino acids.

17. The protein sequencing system of claim 14, further comprising a second reaction chamber in fluid connection with at least one of the fluid outlet ports.

18. The protein sequencing system of claim 17, wherein the mass spectrometer is in fluid connection with the second reaction chamber.

19. The protein sequencing system of claim 14, wherein the protein sequence library is derived from the genome of the organism or group of organisms from which the plurality of unknown protein samples are taken.
